(19) United States
(12) Patent Application Publication
(10) Pub. No.: US 2013/0193622 A1
(43) Pub. Date: Aug. 1, 2013

(54) METHOD FOR FORMING A CONTAINER PROVIDED WITH AN IMPRINT ON AN OVERHEATED AREA

(71) Applicants: Guy Feuilloley, Octeville Sur Mer (FR); Mikael Derrien, Octeville Sur Mer (FR); Caroline Bellec, Octeville Sur Mer (FR); Isabelle Mailot, Octeville Sur Mer (FR)

(72) Inventors: Guy Feuilloley, Octeville Sur Mer (FR); Mikael Derrien, Octeville Sur Mer (FR); Caroline Bellec, Octeville Sur Mer (FR); Isabelle Mailot, Octeville Sur Mer (FR)

(73) Assignee: SIDEL PARTICIPATIONS, Octeville Sur Mer (FR)

(21) Appl. No.: 13/814,620

(22) PCT Filed: Sep. 14, 2011
(86) PCT No.: PCT/FR2011/052094

§ 371 Date: Apr. 11, 2013

(30) Foreign Application Priority Data
Sep. 30, 2010 (FR) 10 03884

(51) Int. Cl. B29D 22/00

(52) U.S. Cl. CPC B29D 22/003
USPC 264/458

(57) ABSTRACT

A method of manufacturing a container having a local recessed or relief impression, from a blank (2) of thermoplastic material. The method includes a heating step in which the blank (2) is exposed to infrared radiation and in which the infrared radiation is monochromatic or pseudo-monochromatic, the intensity of which locally has an extremum in front of a localized zone (11) of the blank, in such a way as to generate a temperature extremum in the zone (11). The method also includes a forming step in which a fluid under pressure is injected into the blank (2) thus heated, and in which the recessed or relief impression is formed at the localized zone (11).

The invention relates to the manufacture of containers, particularly bottles, jars, by forming from blanks (generally preforms, although it can also include intermediate containers) of plastic material such as polyethylene terephthalate (PET).

The manufacture of containers involves two principal steps: a heating step during which the blanks are exposed to electromagnetic radiation from sources emitting in the infrared range, followed by a forming step during which a gas under pressure is injected into the blanks thus heated, to give them the final shape of the container.

Many containers are not symmetrical in revolution and have local impressions, recessed or in relief. Said impressions can be purely aesthetic, or they may have a particular function such as a handle (for example see American patent U.S. Pat. No. 4,123,217 in the name of Fisher), or reinforced feet (for example see French patent FR 2822804 or its American equivalent U.S. Pat. No. 7,051,889, in the name of the applicant, describing a petaloid bottom).

These containers are more difficult and more complex to form than ordinary containers due to a poor distribution of the material, which causes a deterioration of the physical properties of the container, or an opaque and whitish aspect of the material.

Thus, freedom of shapes is often limited by the desire of manufacturers to avoid locally stressing the material too much.

The invention seeks to facilitate the forming of containers having a recessed or relief impression.

To that end, the invention proposes a method of manufacturing a container having a local recessed or relief impression, from a blank of thermoplastic material, said method comprising:
A heating step in which the blank is exposed to monochromatic or pseudo-monochromatic infrared radiation, the intensity of which locally has an
extremum in front of a localized zone of the blank, in such a way as to generate a temperature extremum in said zone;
A forming step in which a fluid under pressure is injected into the blank thus heated, a recess or relief impression being formed at said localized zone.

Said method makes it possible to facilitate making an impression (recess or relief) at the level of a localized zone, the temperature of which is at an extremum, i.e., a maximum or a minimum. The result is greater facility of forming, better dimensional stability of the container, as well as greater freedom of possible container shapes.

According to one embodiment, the superheated zone is localized both axially and radially on the blank, for example on a bottom of the blank.

The infrared radiation, for example, is emitted by a matrix of monochromatic or pseudo-monochromatic radiation sources, subdivided into a main set of sources emitting a radiation of substantially identical average intensity, and a secondary set of sources emitting a radiation, the intensity of which is an extremum: either a maximum, or a minimum, with a difference of at least 10% with respect to the average intensity.

According to one embodiment, the secondary set comprises a series of groups of point sources, separated from each other and forming a periodic motif, which for example has a period equal to the distance covered by a blank during one complete revolution around a principal axis of said blank.

The sources of radiation are for example laser sources, and preferably laser diodes, particularly of the VCSEL type.

Other objects and advantages of the invention will be seen from the following description, provided with reference to the appended drawings in which:

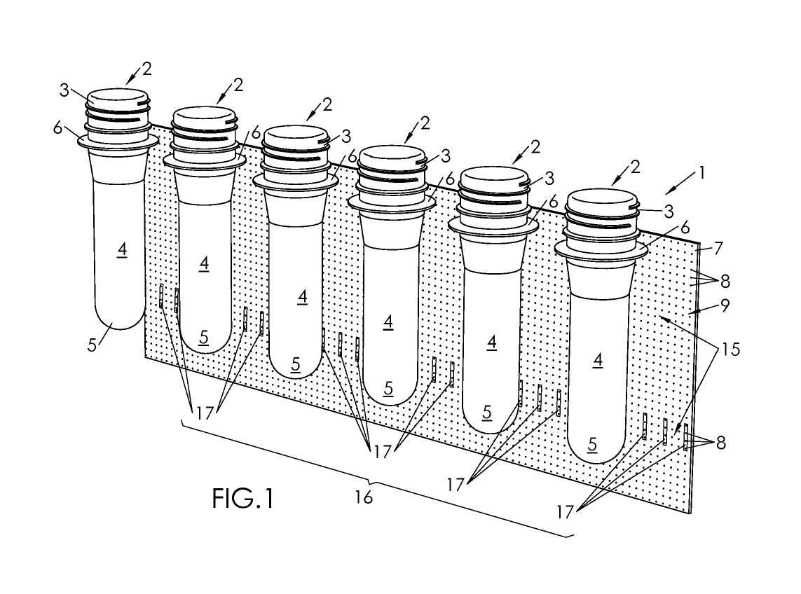

FIG. 1 is a view in perspective partially illustrating a heating unit comprising a wall lined with point infrared sources, in front of which the preforms pass;

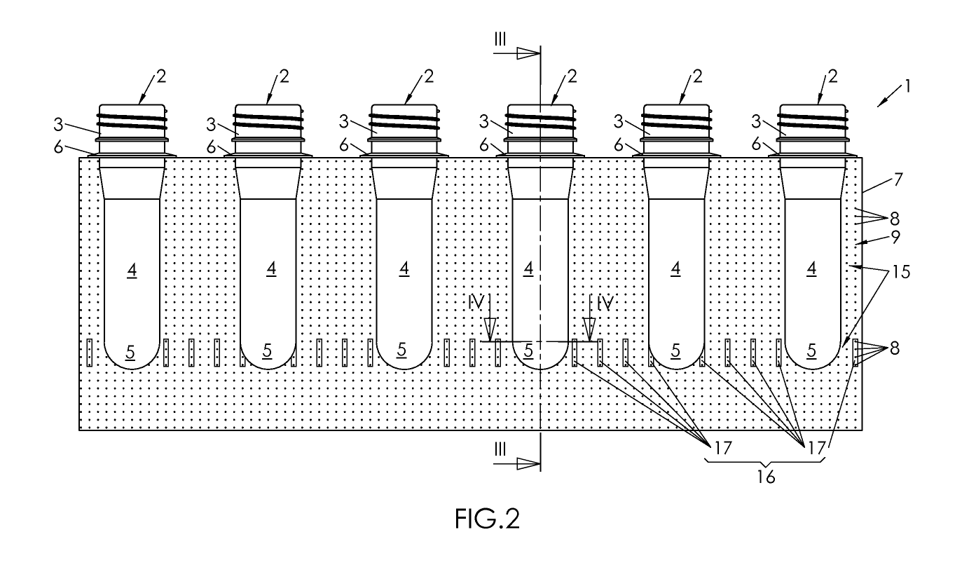

FIG. 2 is a front view of the heating unit of FIG. 1;

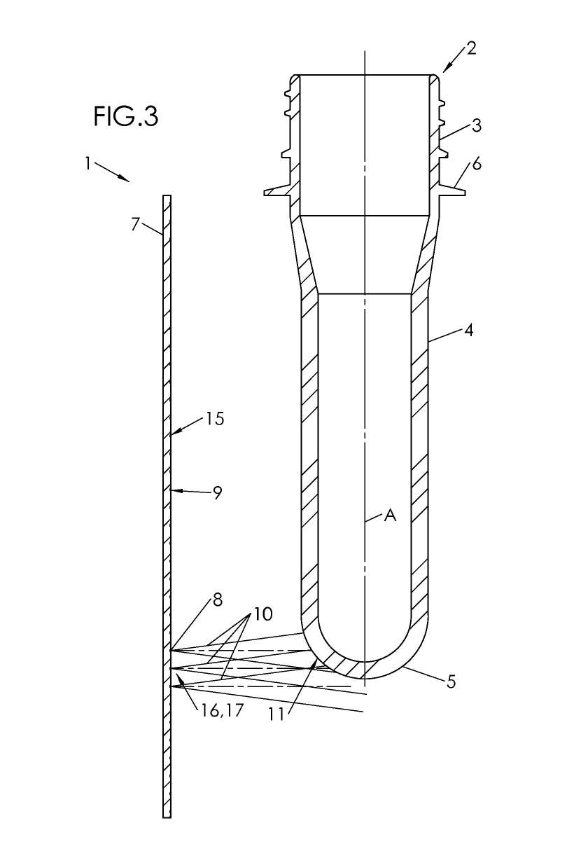

FIG. 3 is a view of the heating unit of FIG. 2, in vertical cross-section along the cutting plane III-III;

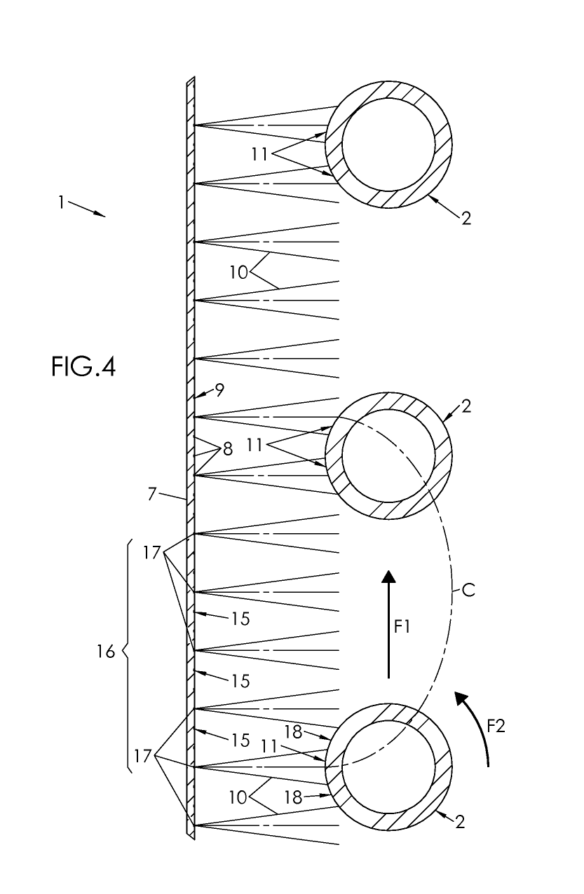

FIG. 4 is a view of the heating unit of FIG. 3, in horizontal cross-section along the cutting plane IV-IV;

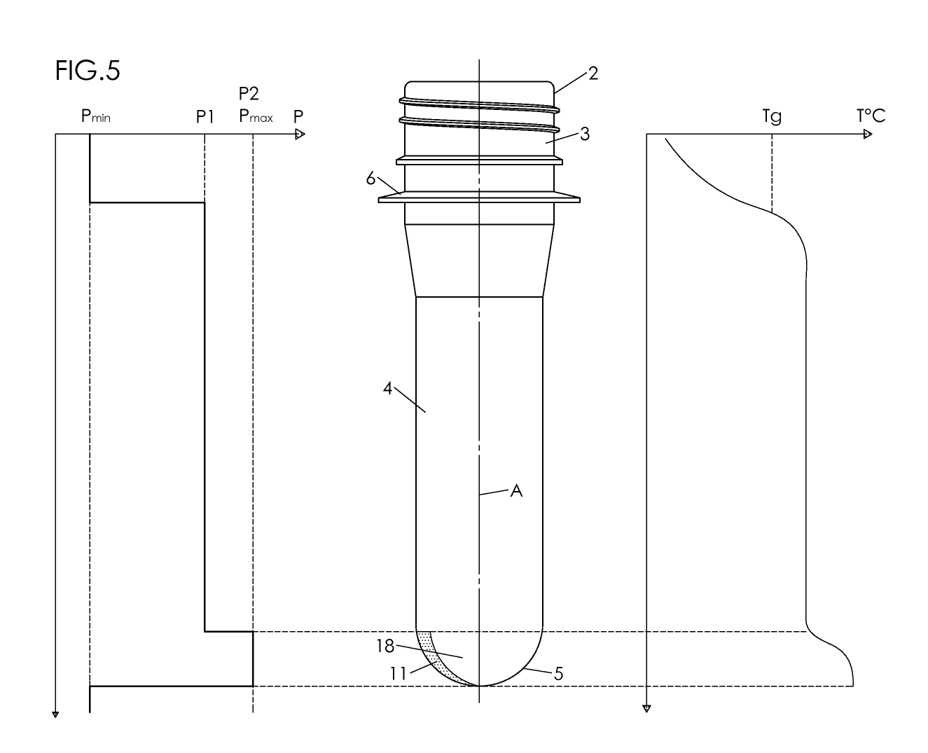

FIG. 5 is a diagram showing, at the center, a selectively heated preform, the diagram on the left illustrating the profile of the intensity radiated by the sources facing the preform, and the thermogram on the right illustrating the variations in temperature of the preform;

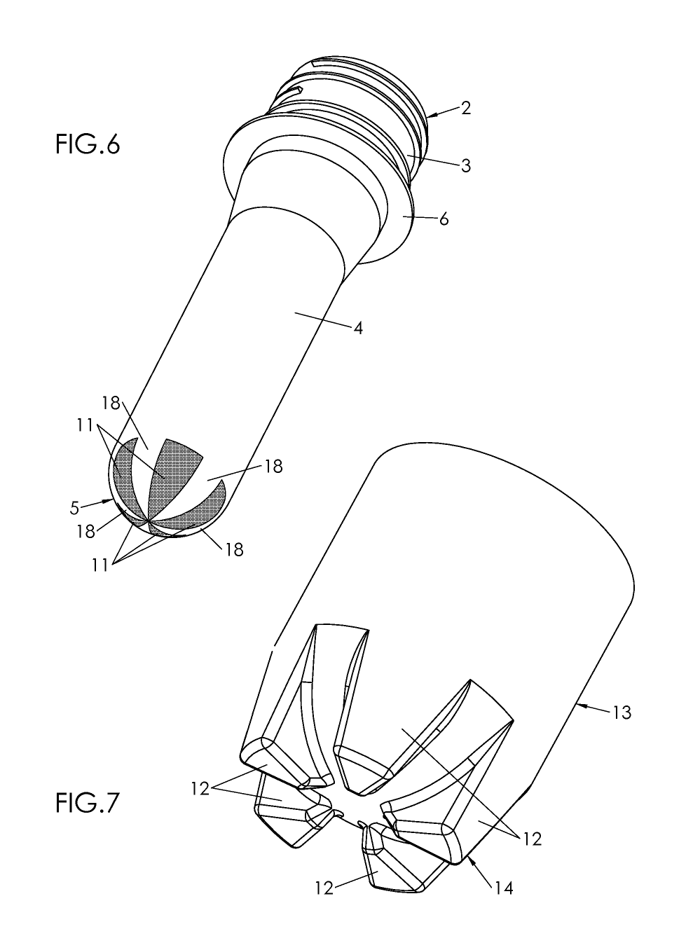

FIG. 6 is a view in perspective from below showing a preform with the superheated zones shaded;

FIG. 7 is a view in perspective from below showing a container with petaloid bottom obtained by forming the preform of FIG. 6.

Diagrammatically represented in FIGS. 1 to 4 is a unit 1 for heating blanks 2 of containers as they pass by. In this instance, the blanks 2 are preforms, but it could involve intermediate containers having undergone temporary forming operations and intended to undergo one or more subsequent operations to obtain the final containers.

Each preform 2, produced from a thermoplastic material such as polyethylene terephthalate (PET), comprises a neck 3, which is not (or only slightly) heated, the shape of which is final, and a body 4 that terminates opposite the neck 3 in a hemispherical bottom 5.

At the junction between the neck 3 and the body 4, the preform 2 has a collar 6 by which the preform 2 is suspended in the various steps of manufacturing the container.

However, in the heating unit 1, the preforms 2 are attached to pivoting supports called spinners, which drive the preforms 2 in rotation around their principal axis A so as to expose the part below the neck (the entire body 4 and the bottom) to the heating. Each spinner comprises a pinion engaging a fixed rack, in such a way that each point situated on the circumference of the preform 1 describes on the trajectory of the preform 2 a cycloid C (drawn in dotted lines in FIG. 4), the period of which is equal to the distance traveled by the preform 2 in one complete revolution (in the direction indicated by the arrow F2 in FIG. 4) around its axis A.

FIGS. 1 to 3 represent the preforms 2 with the neck upwards, but this representation is arbitrary and illustrative, and the preforms 2 could be oriented with the neck downwards.

The heating unit 1 has a radiating wall 7 in front of which the preforms 2 travel. Said wall 7 is lined with a plurality of electromagnetic radiation sources 8 emitting both monochromatic (or pseudo-monochromatic) and directive electromagnetic radiation towards the preforms 2, in the infrared range.

In theory, a monochromatic source is an ideal source emitting a sinusoidal wave at a single frequency. In other words, its frequency spectrum is composed of a single ray of zero spectral width (Dirac).

In practice, such a source does not exist, a real source being at best quasi-monochromatic, i.e., its frequency spectrum extends over a band of spectral width that is small but not zero, centered on a principal frequency where the intensity of radiation is maximum. In common parlance, however, such a real source is called monochromatic. Moreover, a source emitting quasi-monochromatically over a discrete spectrum comprising several narrow bands centered on distinct principal frequencies is considered to be “pseudo-monochromatic.” This is also called multimode source.

In practice, the sources 8 are organized by juxtaposition and superposition to form a matrix 9. For example, this involves laser sources 8, and preferably laser diodes. According to a preferred embodiment, the matrix 9 is a matrix of vertical-cavity surface-emitting laser (VCSEL) diodes 8, each diode 8 emitting for example a laser beam 10 of rated individual power on the order of a milliwatt at a wavelength situated in the short and medium infrared range—for example on the order of 1 μm.

At the scale of the preforms 2, the diodes 8 can be considered as point sources, each emitting directive radiation, i.e., in the form of a conical light beam 10, the solid half-angle of which is closed at the top, and preferably between 10° and 60°. The beam 10 can be symmetrical in revolution (i.e., of circular cross-section), or non-symmetrical in revolution (for example elliptical cross-section).

The object of the present application is not to describe in detail the structure of the matrix 9 of diodes 8. For this reason, the matrix 9 is represented in a simplified manner, in the form of a plate, the diodes 8 appearing in the form of points.

The heating unit 1 is designed to enable a modulation of the power (also called intensity) of the radiation emitted by each diode 8, or by groups of diodes.

Such modulation can be performed electronically, the power of the diodes 8 being for example displayed on a control monitor. Said monitor can be a touch screen, and for a given group of diodes, can display a cursor, the movement of which causes the modulation of the power of the radiation emitted by the diodes 8 of the group to a value between a predetermined minimum value Pₘᵢₙ (for example zero) and a maximum value Pₘₐₓ corresponding for example to the rated power of the diodes 8.

The purpose is to achieve a differential heating, i.e., selective and non-uniform, of each preform 2, in such a way as to obtain locally on said preform at least one localized zone 11, both axially (i.e., in the height of the preform 2) and radially (i.e., in the circumference of the preform 2), in which the temperature has an extremum (maximum or minimum) with respect to its vicinity. In other words, the purpose is to locally superheat, or on the contrary underheat, the preform 2.

According to a particular embodiment, the purpose is to obtain superheated zones 11, located for example on the bottom 5, particularly in order to facilitate the production of feet 12 during the forming of a container 13 with a petaloid bottom 14, as we will see hereinafter. Said zones 11 are located not only axially, but also radially on the bottom 5 of the preform 2.

To that end, the matrix 9 is subdivided into two sets of diodes, to wit:
A main set 15, connected, the diodes 8 of which emit a radiation, the intensity P1 of which is set at an identical average value, for example less than the maximum power Pₘₐₓ (particularly with an attenuation of between 10% and 20%);
A secondary set 16 composed of a series of fixed point groups 17 of diodes 8 emitting a radiation, the intensity of which is set at an extreme value P2 (constant and identical within each group 17), with a difference of at least 10% and possibly up to 20% of the value P1 (according to one embodiment illustrated in FIG. 5, where the diodes of the secondary set 16 are set at a peak intensity, the intensity P2 is equal to the maximum power Pₘₐₓ while the average intensity P1 is equal to about 80% of the maximum power Pₘₐₓ).

The term “point” does not mean that each group 17 is necessarily reduced to a single diode 8 (although this is possible) or that each group 17 comprises a negligible number of diodes 8. It means on the one hand that each group 17 is related, its diodes 8 being adjacent, and on the other hand that the area occupied by each group 17 of diodes 8 is small with respect to the total area of the matrix 9.

The groups 17 of diodes 8 of the secondary set 16 are separated and dispersed along the trajectory of the preforms 2. They are separated from each other, while together forming a periodic motif depending on the configuration of the zone 11 (or zones) on the preform 2 to be superheated (or conversely underheated). Thus, in order to localize the intensity P2 of heating on zones 11 situated on the bottom 5 of the preforms 2, the secondary set 16 is formed by a linear horizontal series of groups 17 of diodes 8 situated at the height of and facing the bottom 5 of the preforms 2.

Each group 17 of diodes 8 defines a closed contour corresponding substantially to the contour of the localized zone 11. Thus, in the illustrated example, where the zones 11 are angular sectors located on the bottom 5 of the preform 2, the contour of the groups 17 of diodes 8 of the secondary set 16 is substantially triangular, with a peak of the triangle pointing downwards and towards the opposite side of the horizontal triangle.

To each localized zone 11, in the secondary set 16, there corresponds a subset of groups 17 of diodes 8 equally distributed along the trajectory (indicated by the arrow F1 in FIG. 4) of the preform 2 and having a separation between them equal to the distance traveled by the preform 2 in one complete revolution around its axis A, said distance being itself equal to the average perimeter of the pinion of the spinner to which the preform 2 is attached.

In the configuration illustrated in FIGS. 6 and 7, where five equally distributed angular sectors 11 on the bottom 5 of the preform 2 must be heated differentially, no subset of groups 17 of diodes 8 is distinguished, the secondary set 16 in effect comprising a regular series of equidistant groups 17 of diodes 8 of triangular contour, the separation between two adjacent groups 17 being equal to one-fifth of the perimeter of the pinion.

The adjustment of the shape and size of the point groups 17 of diodes 8 can be adapted according to various factors, in particular:
the solid angle of the light beams 10 emitted by the diodes 8: indeed, the beams 10 being divergent, the corresponding lighted zone on the preform 2 has an area greater than that of the group 17 of diodes 8;
the distance of the preform 8 to the matrix 9: combined with the aforementioned solid angle, this distance has an impact on the size of the zones of the preform 2 lighted by the groups 17 of diodes 8;
the possible presence of reflectors facing the matrix 9, which can have an influence on the distribution of the radiation on the preform 2.

Moreover, because of the non-homogeneous nature of the heating, it is necessary to ensure that the angular orientation of the preform 2 is correct during its insertion into a mold upon completion of the heating. To that end, the preform 2 can be provided with an orientation reference mark (for example in the form of a notch made at the neck 3) capable of being detected by the mechanical (or optical) control means guaranteeing the proper angular orientation of the preform 2 at all times. According to a particular embodiment, the preforms 2 are transferred from the heating unit 1 to a mold by means of tongs provided with a projecting spur that lodges in the notch of the preform 2, in such a way that the correct orientation of each preform 2 is maintained throughout the transfer until the insertion of the preform 2 into the mold.

To heat the preforms 2, they are moved through the heating unit 1 while turning them around their axes A, in such a way as to expose their part beneath the neck (body 4 and bottom 5) to the radiation from the diodes 8. Because of the particular configuration of the matrix 9 as described above, localized zones 11 on the bottom 5 of the preform 2 are repeatedly and periodically exposed to the differential radiation from the groups 17 of diodes of the secondary set 16, and consequently undergo differential heating (in this instance superheating), while the other parts of the preform 2 (i.e., the remainder of the bottom 5 and all of the body 4 in the illustrated example) are exposed to the radiation from the diodes 8 of the main set 15 and consequently undergo heating of average intensity.

The temperature differential measured in the superheated (or on the contrary underheated) zones 11 and in the normally heated zones is illustrated in the thermogram of FIG. 5 (to the right): it can be seen in this instance that the superheated zones 11 have a temperature exceeding that of the normally heated zones by at least 10% (and preferably 20%). To that end, a difference of at least 10% (and preferably 20%) will be maintained between the power of the diodes 8 of the secondary set 16 and the power of the diodes 8 of the main set 15, as is illustrated in the diagram of FIG. 5 (to the left). Obviously, the temperature variations within the preform 2 are continuous, due to the divergence of the beams 10 as well as to the diffusion of the heat within the material. However, these variations are relatively sharp due to the concentration of power allowed by the laser diodes 8.

Thus, upon completion of heating, the body 4 of the preform 2 has a substantially uniform wall temperature, and the bottom 5 of the preform 2 has normally heated angular sectors 18, the temperature of which is substantially equal to that of the body 4, alternating with superheated (or on the contrary underheated) angular sectors 11 (shown shaded in FIG. 6).

The deformability of the localized superheated zones 11 is high, greater than that of the sectors 18, which facilitates the formation of relief impressions in the zones 11. The deformability of the underheated zones 11 is less, which allows—unlike the formation of relief impressions around the zones 11—the formation of recessed impressions in the zones 11.

Upon exiting from the heating unit 1, the preform 2 is transferred into the mold, its angular orientation being controlled as indicated above, in such a way that the angular sectors 11 of the preform 2 having undergone a differential heating are located in vertical alignment or in front of recessed (or, on the contrary, relief) parts of the mold. A fluid under pressure (for example a gas such as air) is injected into the preform 2 by means of a nozzle that is sealably applied around the neck 3 on the upper face of the mold.

In the example illustrated in FIG. 7, where the container comprises a petaloid bottom 13 provided with a perimetric series of projecting feet 12, the mold correspondingly comprises a bottom provided with a perimetric series of recessed reserves into which the superheated sectors 11 can easily be stretched due to the high local deformability of the material.

Following is a summary of the principal advantages of the method described above.

The heating of the preform 2 performed by means of infrared radiation from directive monochromatic sources (such as laser) is sufficiently precise to obtain marked temperature variations between the superheated (or underheated) localized zones 11 and the comparatively less heated (respectively more heated) surrounding zones. The high deformability of the localized superheated zones 11 makes it possible to facilitate the formation of relief impressions (such as the feet 12 on a petaloid bottom 14, as we have seen) or recessed impressions (for example by means of movable inserts, for example to form handles on the body of the container).

The results are:
On the one hand, in the highly deformed regions (for example the feet of a petaloid bottom), the overstretching of the material is avoided along with its negative consequences (appearance of cracks, whitening of the material);
And on the other hand, quality forming can be performed at pressures (on the order of 20 bars or less) that are less than the ordinary pressures (on the order of 35 bars) required for the proper impression of highly deformed zones. This results in substantial economies of energy.

1. Method of manufacturing a container (13) having a local recessed or relief impression (12), from a blank (2) of thermoplastic material, said method comprising:
A heating step in which the blank (2) is exposed to infrared radiation;
A forming step in which a fluid under pressure is injected into the blank (2) thus heated;
Characterized in that:
in the heating step, the infrared radiation is monochromatic or pseudo-monochromatic, the intensity of which locally has an extremum in front of a localized zone (11) of the blank, in such a way as to generate a temperature extremum in said zone (11);
said zone (11) is localized both axially and radially on the blank (2);
In the forming step, the recessed or relief impression (12) is formed at said localized zone (11).

2. Method according to claim 1, characterized in that the other parts of the blank (2) are exposed to radiation of average intensity.

3. Method according to claim 1, characterized in that said zone (11) is located on a bottom (5) of the blank (2).

4. Method according to claim 1, characterized in that the infrared radiation is emitted by a matrix (9) of monochromatic or pseudo-monochromatic radiation sources (8), subdivided into a main set (15) of sources (8) emitting radiation of average intensity and a secondary set (16) of sources (8) emitting radiation of extreme intensity, situated in front of the zone (11) to be superheated.

5. Method according to claim 4, characterized in that there is a difference of at least 10% between the extreme intensity and the average intensity.

6. Method according to claim 4, characterized in that the secondary set (15) comprises a series of groups (17) of point sources (8), separated from each other and forming a periodic motif.

7. Method according to claim 6, characterized in that the motif formed by the groups (17) of point sources (8) has a period equal to the distance traveled by a blank (2) during one complete revolution around a principal axis (A) of said blank.

8. Method according to claim 6, characterized in that the sources (8) of radiation are laser sources.

9. Method according to claim 8, characterized in that the radiation sources (8) are laser diodes.

10. Method according to claim 9, characterized in that the diodes (8) are of the VCSEL type.
